(19) United States
(12) Patent Application Publication
(10) Pub. No.: US 2011/0099063 A1
(43) Pub. Date: Apr. 28, 2011

(54) My Life Cost (MLC) Systems and Methods

(76) Inventor: Paul Clemmons, Canyon, TX (US)

(21) Appl. No.: 12/908,873

(22) Filed: Oct. 20, 2010

Related U.S. Application Data
(60) Provisional application No. 61/279,384, filed on Oct. 20, 2009.

(51) Int. Cl. G06Q 40/00; G06Q 30/00

(52) U.S. Cl. 705/14.49; 705/35

(57) ABSTRACT

According to an exemplary embodiment, the My Life Cost system and method includes a budgeting and business marketing software application that detects, tracts, stores and analyzes financial transactions of a member to provide financial incentives and influence consumer spending. The My Life Cost system and method monitor the amount of money, credit or budgeted category that a member has available to spend on specific merchandise and services. In further exemplary embodiments, the My Life Cost system and method includes an interactive financial coach that helps members make informed spending choices. Still according to other exemplary examples, the My Life Cost method and system provides marketing services to qualified businesses on a commission basis without any required upfront costs or any additional advertising fees. My Life Cost earns a commission from a participating merchant or business when a sale is made by one of its member. In further exemplary embodiments, the My Life Cost system and method includes on-line reports or notifications to a communications device that may be customized for each member and for each participating merchant or business.

### RELATED COPENDING APPLICATION

This application claims priority benefit of co-pending U.S. Provisional Patent Application No. 61/279,384 filed Oct. 20, 2009, titled “MY LIFE COST (MLC) SYSTEM AND METHOD” having Paul Clemmons as inventor and which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to financial management systems.

II. Background

Managing finances is a challenge especially for individuals or families with modest incomes. Many individuals do not have the time to track all of the month's expenditures so that spending habits can be modified to save for a new home or to pay-off existing debt (if any).

Thus, there is a continuing need for a system that automatically tracks expenditures by budget category and automatically notifies the user of the expenditure and remaining balance for the budget category.

There is a continuing need for a system that provides the user a discount savings on a purchase of goods or services and saves at least a portion of the savings or other financial incentive into some type of account, such as a user reserve/savings account.

There is a continuing need for a system that tracks a plurality of budget categories and allows each user to selectively allocate a monthly, daily or yearly budget limit per category. As purchases are made, the budget category is debited by the amount of the purchase. An electronic notification, of the transaction, is then generated identifying the remaining category budget amount, category budget limit, and one or more budget reconciliation options.

There is a continuing need for a system that performs a financial physical based on the users profile to determine any cost savings that can be generated such as by obtaining new insurance for home, car, life, etc., and/or obtaining a new mortgage.

There is a continuing need for a system that pays bills for the user.

There is a continuing need for a system that actively seeks affiliates that offer discount saving to members associated with the system. Alternatively, the system could be used for advertisements or marketing to selected users or members as part of a financial incentive.

There is a continuing need for a system that tracks the user reserve/savings account for retirement investment or other high-yield investments.

### SUMMARY

The aforementioned problems, and other problems, are reduced, according to exemplary embodiments, by the My Life Cost (MLC) systems and methods described herein. My Life Cost is a consumer budgeting and business marketing application that creates a unique environment for businesses to reach consumers. According to some of the exemplary embodiments, My Life Cost issues complimentary budgeted debit cards (e.g., Visa, MasterCard, etc.) that track and influence consumer spending. The MLC application constantly monitors the amount of money cardholders have available to spend on specific merchandise and services. In further exemplary embodiments, the My Life Cost system and method includes an interactive financial coach that helps consumers make informed spending choices.

According to other exemplary examples, the My Life Cost method and system provides marketing services to qualified businesses on a commission basis without any required upfront costs or any additional advertising fees. My Life Cost earns a commission from a participating merchant or business when a sale is made by one of its cardholders. In further exemplary embodiments, the My Life Cost method and system helps to maximize sales potential by offering complimentary on-line reports that show a merchant or advertiser how many of its members have made purchases from the participating business and its competitors, how much was spent in its store and similar businesses and how much money is still budgeted from its cardholders to be spent in its type of business.

Still further, some of the exemplary embodiments of the My Life Cost method and system include a database of over 28,000 combinations of cardholder demographics and provide a cost effective means to target the consumer profiles.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### DESCRIPTION OF THE DRAWINGS

The exemplary embodiments, objects, uses, advantages, and novel features are more clearly understood by reference to the following description taken in connection with the accompanying figures wherein:

FIG. 1 illustrates a block diagram of the My Life Cost (MLC) System in accordance with some embodiments of the present invention;

FIG. 2 illustrates a block diagram of a processing device that include the My Life Cost module stored in memory in accordance with some embodiments of the present invention;

FIGS. 3A-3B illustrates a block diagram of My Life Cost website functionality in accordance with some embodiments of the present invention;

FIG. 4 illustrates a block diagram of a My Life Cost client folder/account in accordance with some embodiments of the present invention;

FIG. 5 illustrates a block diagram of a member's MLC budget graphical user interface (GUI) in accordance with some embodiments of the present invention;

FIG. 6 illustrates a block diagram of a participating merchant transaction data stream in accordance with some embodiments of the present invention; and

FIG. 7 illustrates a block diagram of the merchant transaction, commission/discount and savings database in accordance with some embodiments of the present invention.

FIG. 8 provides a exemplary illustration of the My Life Cost website home page functionality in accordance with some of the embodiments of the present invention;

FIG. 9 illustrates an exemplary My Life Cost graphical user interface of a consumer objective to establish budget categories and eliminate debt (if any) in accordance with some of the embodiments of the present invention.

FIGS. 10A, 10B, 10C and 10D illustrate exemplary My Life Cost graphical user interfaces that assist a consumer in making an informed spending decision in accordance with some of the embodiments of the present invention.

FIG. 11 illustrates a block diagram of a My Life Cost method and system that provide an online financial coach to assist with informed consumer spending in accordance with some of the embodiments of the present invention.

FIGS. 12A thru 12H illustrate an exemplary query or interactive online form for collecting consumer data in accordance with some of the embodiments of the present invention.

FIG. 13 illustrates a flow chart depicting the My Life Cost method in accordance with some of the embodiments of the present invention.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The MLC system is an online system accessed via a website on the World Wide Web (WWW) or via alternate communication protocols (e.g., PSTN or MSO). The MLC system is configured to selectively manage a plurality of financial matters associated with a MLC member and find, solicit and selectively obtain cost savings associated with financial matters that may be used by a member.

For example, the MLC system is configured to perform an insurance physical. The insurance physical selectively evaluates life insurance, health insurance, homeowner insurance, flood insurance, car insurance, and other insurances to determine if adequate coverage is currently being provided and/or whether more or less insurance coverage is needed. The MLC system is configured to solicit, on behalf of the member, insurance quotes for a selected insurance product (the selected insurance product may include one or more of car insurance, flood insurance, homeowners insurance, health insurance, life insurance, umbrella insurance, etc.). As is known, some insurance companies may provide lower rates for multiple policies such as car, home and umbrella policies. If the member opts to get a new insurance, the MLC system may capture a portion of the cost savings as a revenue share for the MLC system. Alternatively the MLC software application may select member profiles to query to see if the member wants a quote for a new insurance policy. If the member answers yes, then the MLC system presents an online interactive questionnaire (may be populated with some aggregated data stored in the MLC databases) to request member information, confirm member information, and obtain authorization to communicate member information to others for a new quote. Still further, other exemplary embodiments of the MLC system provide pre-approved quotes based on a member's profile based upon member data stored in the MLC databases.

Cost savings are tracked by the website. The MLC member would have an option to place all or a portion of such savings into an interest bearing account (reserve savings accounts).

The MLC system is configured to manage financial matters to save the MLC member money and manage the member's budget. For example, the MLC system may determine that the current industry interest rate of a member's mortgage is more than the current rate. The MLC system is configured to notify the member that potential savings are available. The MLC system is configured to selectively solicit a new mortgage with a new lower rate at the member's request. The system may be configured to provide a prompt to the user to selectively request a search of a new lower mortgage. Results of such a search would be provided to the member with the ability for the member to select a mortgage. In the exemplary embodiment, the search or request for a mortgage may be executed with a plurality of strategic merchants or participating businesses. If the member opts to get a new mortgage, the MLC system may capture a portion of the cost savings as a revenue share for the MLC system. A merchant may include a title company to handle real estate transactions for a discounted price.

The MLC system is configured to harness the buying power of the MLC members to obtain discount rates for the MLC members with vendors, retailers, etc. Each vendor may become a merchant to offer savings or discount rates to MLC members making purchases. The MLC system may be configured to capture a portion or percentage of the savings as a revenue share. Cost savings are calculated by the MLC website wherein a portion of the cost savings (amount saved in transaction minus website revenue share) is saved for the member in an interest bearing account (MLC savings accounts). The cost savings leverage “life cost” of each member such that each member purchase returns a marketing fee, commission or incentive to the member.

The MLC system is configured to interface with the member over the Internet or via other communication medium. However, one or more of the functions of evaluation, solicitation, notification may be performed by or require human intervention or action.

The MLC system notifies and updates members automatically based on expenditures and does not require the member to manually enter expenditures. The MLC system does not require the member to keep and store receipts until the expenditures are entered.

The MLC system automatically tracks expenditures by budget category and automatically notifies the member of an expenditure and balance for the budget category.

The MLC system provides the member a rebate, savings, or other financial incentive on a purchase of goods or services. In an exemplary embodiment, the MLC system may debit a financial account or saving account from the member's bank account (or credit account or other financial account) and saves at least a portion of the savings in a members reserve/savings account and a portion in an operating account for the MLC provider. The member's bank account may be populated with money to cover a portion or all of the month's expenditures. As the bills are paid and/or expenditures related to the member's budget are debited, the member's bank account is adjusted accordingly.

The MLC system tracks a plurality of budget categories and allows each member to selectively allocate a monthly, daily, or yearly budget limit for one or more categories. As purchases (transactions) are made, the budget category is adjusted by the amount of the purchase/transaction and an electronic notification of the purchase transaction is generated identifying the remaining category budget amount, category budget limit, and/or one or more budget reconciliation options. The system may show a variance so that the member can evaluate whether or not an adjustment is necessary or the overage was a one-time occurrence. Additionally, the member can reduce spending in other categories to stay within the monthly budget; this requires prioritization and decision making.

The MLC system can pay bills for the member with an automated bill pay service.

The MLC system is configured to actively seek merchants that offer financial incentives, marketing fees, savings, rebates, discounts, and/or marketing fees that may be shared with the provider of the My Life Cost services and with the MLC member. For example, if the merchant provides a $1.00 incentive, then the MLC provider may receive $0.50 and the member may receive $0.50.

The MLC system tracks the member's reserve/savings account wherein once a predetermined amount is achieved, the member is offered to use some of the savings in the account to purchase or invest in an IRA, mutual fund, stocks, bonds or another interest earning financial instrument.

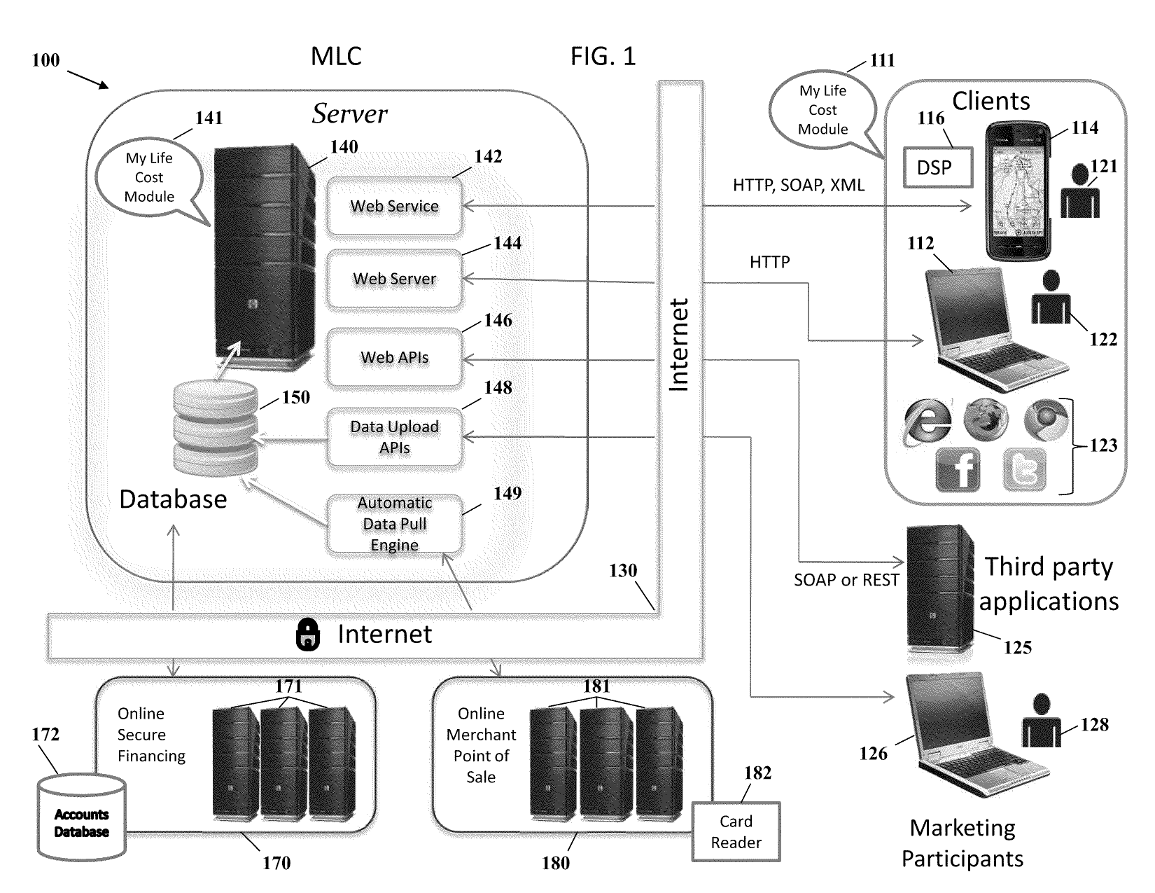

FIG. 1 illustrates a block diagram of my life cost (MLC) system in accordance with some embodiments of the present invention. The system includes MLC website in communications (wired or wireless) with one or more cost saving affiliate points of sale (merchant-POS) and one or more members and one or more potential members. The merchant may include insurance companies, mortgage companies, real estate companies, travel agencies, stock brokerage firms, retailers, restaurants, fast food restaurants, clothing stores, music stores, car dealerships, boat dealerships, wholesalers, grocery stores, other websites or web-based services, etc.

The members or potential members may communicate with the website via the World Wide Web (WWW), Internet, Extranet, or Intranet. The communication medium may be compatible with WiFi communications, IEEE 802.11 communications, XDSL, DSL, etc. According to alternate embodiments, the My Life Cost module may operate in a device communicating with a telecommunications system (not shown). The telecommunications system may include wired, optical, and/or wireless elements. This telecommunications system further represents an alternate operating environment and the MLC module operates within the memory (such as memory subsystem, flash memory, or peripheral storage device) of a computer system. The telecommunications system includes a telecommunications switch of the PSTN. Alternatively, the telecommunications system may include private network elements, such as private branch exchanges (PBXs), and/or other elements. The telecommunications switch includes Advanced Intelligent Network (AIN) componentry controlling many features of the telecommunications switch. The telecommunications switch could also include a packet-based “soft switch” that uses software control to provide voice, data, and video services by dynamically changing its connection data rates and protocols types. If the telecommunications system should include a softswitch, the AIN componentry is replaced by an application server that interfaces with the softswitch via a packet protocol, such as Session Initiation Protocol (SIP). The computer system may also interface with a data network via a connection to the telecommunications switch. The signaling between the telecommunications switch, the PSTN including the AIN, and the data network, however, are well understood in the art and will not be further described. Those of ordinary skill in the art will be able to apply the principles of the invention to their own network configurations which may differ substantially from the system as shown in FIG. 1.

The MLC method and system involves at least one electronic device that has a digital signal processor which may store and make use of audio files, as well as an electronic device that has the capability to access and download material from the World Wide Web (WWW). These two functions may or may not be contained within the same electronic device. These devices may include, but are not limited to cell phones, laptops, desktop computers, iPads, etc. Devices that may download the audio tracks from the web-accessible device include but are not limited to clocks, personal electronic planners, iPods, digital picture frames, digital watches, electronic oven and kitchen timers, sports devices such as pedometers or heart rate monitors, cell phones, laptops, desktop computers, iPads, electronic book readers (e.g. Kindle), CDs, USB drives, and any other electronic devices with digital signal processing ability.

FIG. 1 further depicts an operating environment 100 for further exemplary embodiments of this invention. This embodiment of MLC method and system includes a computer program that allows a customer to customize notification alerts presented by a PC or IP communications device servicing a called telephone number (or to a Service Node address). As used herein, the term “IP communications device” includes a wireless phone, a cellular phone, a satellite phone, a computer, a modem, an audio pager, a personal digital assistant, a digital signal processor, a global positioning system transceiver, an interactive television, and other IP addressable communications devices capable of delivering audio communications. MLC method and system allows the customer to select a desired format for provide a ticker of information fields with a snapshot of real time financial spending data that are typically accessible in a communications network. For example, the identification fields may include information associated with at least one of the following: total budget authorized, total budget spent, one or more categories that show detailed amounts of spending, one or more categories with amounts that exceed budget, a time of day, a date identifier (e.g., day of week or calendar date), a communications address to a MLC coach for help, and/or other information.

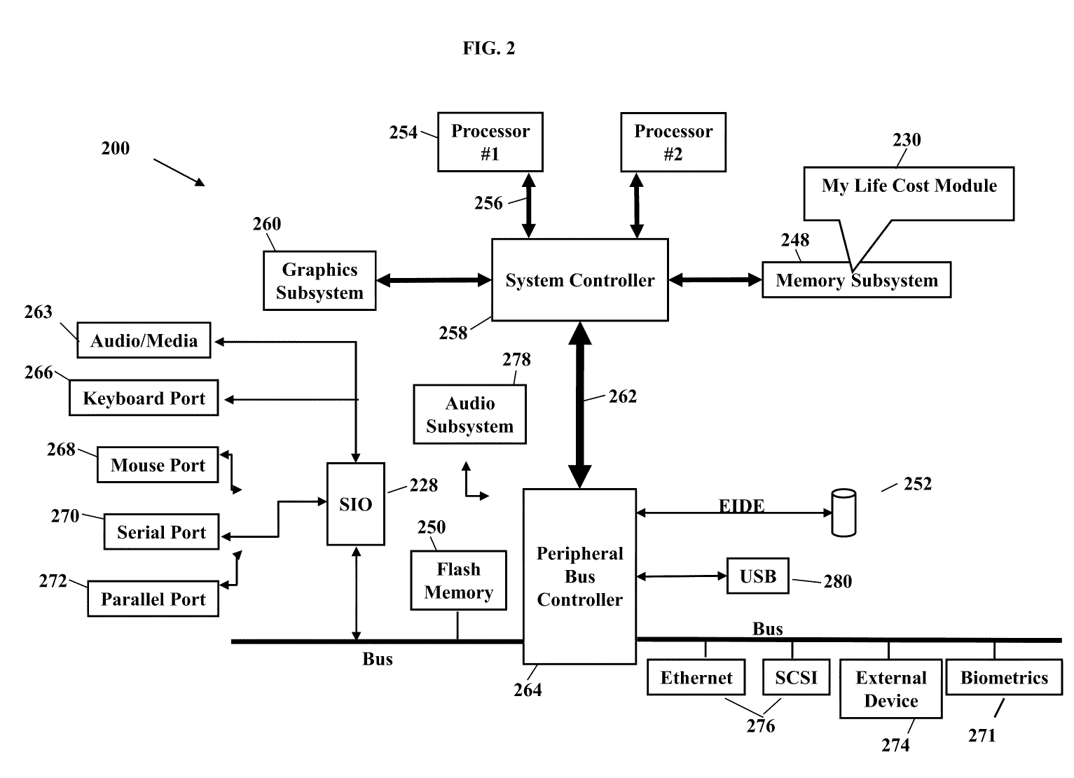

FIG. 2 is a block diagram showing the MLC method and system residing in a computer system 200 and/or smart phone system. The MLC method and system operates within a system memory device. The MLC method and system, for example, is shown residing in a memory subsystem 248. The MLC method and system, however, could also reside in flash memory 250 or peripheral storage device 252. The computer system also has one or more central processors 254 executing an operating system. The operating system, as is well known, has a set of instructions that control the internal functions of the computer system. A system bus 262 communicates signals, such as data signals, control signals, and address signals, between the central processor and a system controller 258 (typically called a “Northbridge”). The system controller provides a bridging function between the one or more central processors, a graphics subsystem 260, the memory subsystem, and a PCI (Peripheral Controller Interface) bus 262. The PCI bus is controlled by a Peripheral Bus Controller 264. The Peripheral Bus Controller (typically called a “Southbridge”) is an integrated circuit that serves as an input/output hub for various peripheral ports. These peripheral ports could include, for example, an audio/media port 263, a keyboard port 262, a mouse port 268, a serial port 270 and/or a parallel port 272 for a video display unit, one or more external device ports 274, and networking ports, such as SCSI or Ethernet 276 or a biometrics port 271. The Peripheral Bus Controller could also include an audio subsystem 278.

The processor 254 is typically a microprocessor. For example, Advanced Micro Devices, Inc. manufactures a full line of microprocessors. The Intel Corporation also manufactures a family of microprocessors. Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com).

The system memory device (shown as memory subsystem, flash memory, or peripheral storage device) may also contain an application program. The application program cooperates with the operating system and with a video display unit (via the serial port and/or the parallel port) to provide a Graphical User Interface (GUI). The Graphical User Interface typically includes a combination of signals communicated along the keyboard port and the mouse port. The Graphical User Interface provides a convenient visual and/or audible interface with the customer or user of the computer system. As is apparent to those skilled in the art, the selection and arrangement of the audio a MLC method and system may be programmed over a variety of alternate mediums, such as, for example, an interactive online data entry form, a voice-activated menu prompt, an interactive session with an telecommunications network administrator, and the like.

The system is configured to allow web-enabled devices of MLC members to communicate with the WWW to receive transaction updates; email notifications; discount advertisements; investment information; insurance information; current, pending, or monthly bill payments; and/or other financial based transactions or information. The MLC members may be notified of loan approval, mortgage rates, mortgage rate savings, retirement investments, real estate agent services and travel services.

In the exemplary embodiment, MLC members would have a client folder/account which is accessible by the member 24 hours a day. The MLC member would have access to all transactions pertaining to the MLC member for discounts, sales, savings from a merchant, account withdrawals, account credits, account debits, account deposits, etc.

The web-enabled devices may include wired or wireless devices. The web-enable device may include a cellular phone, a terminal, personal computer (PC), a wirelessly-equipped personal digital assistant (PDA), a wireless communications device, laptop computer, etc. The wireless communications may be a Code Division Multiple Access (CDMA) system, a Global System for Mobile Communications (GSM) system, satellite communications, cellular communication, mobile communications, or some other system.

The website is comprised a web-based platform configured to execute a set of programs configured to interface with the web-enabled devices, computers, and/or through the WWW. The web-based platform includes one or more processors, computers, servers to execute the set of programs to provide access to the website, set up and store member information, set up client folders, and access to and from the folders, interact with merchant, the Bank Card Issuer, etc.

The website may include one or more storage units or databases, database servers, etc. for downloading or storing information such as pending financial transactions, discounted transactions, financial transactions, MLC discounted transactions, bill payments, and account balances. The website may store other member information and may include a plurality of client folders. Each client folder is individually accessible by a client or others given permission or access privileges to the client's folder or portions of the client's folders. The folders may store information related to insurance, mortgage rates, insurance information, and current bills.

The MLC system may include a financial investment solicitation and investment unit with GUIs. As the member builds wealth in the reserve savings account, the system may query the member for possible investment in financial instruments such as stocks, bonds, CDs, etc. The system may work with brokerage firms to offer such a service.

The client folder/account provides a GUI for the member to browse and navigate through the financial statements and transaction, bill payments, bills, etc.

The website includes one or more client folders, any number of one or more database or storage units, and support for any number of members and/or clients, according to the particular needs of the system.

The website may include one or a variety of user client side interfaces.

The term “unit” as described herein may include software, program, application, module, e-forms, e-statements, a combination of hard copy forms, and e-forms.

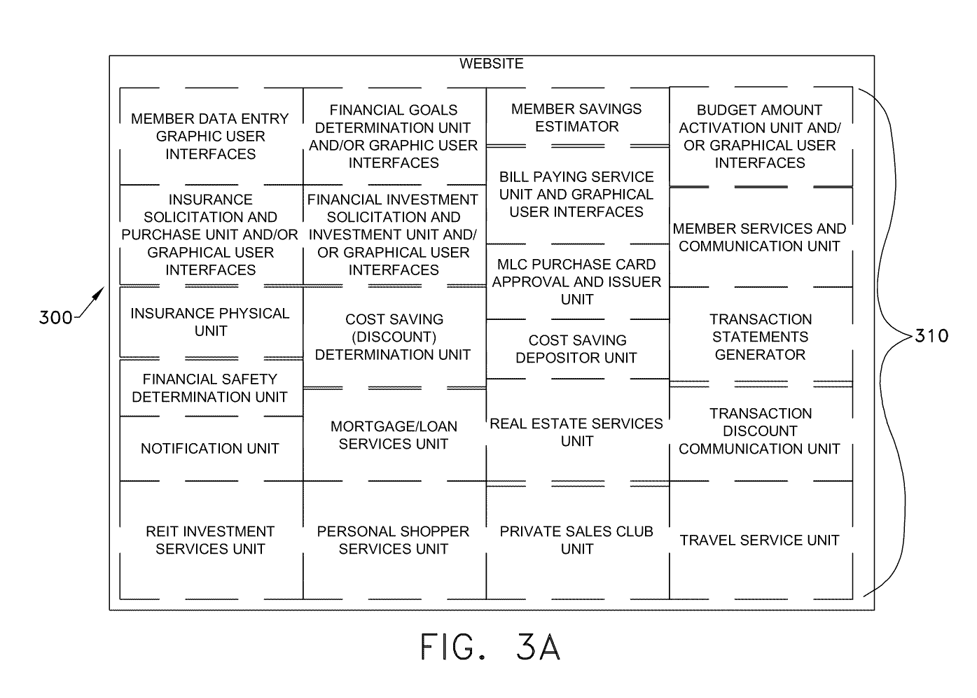

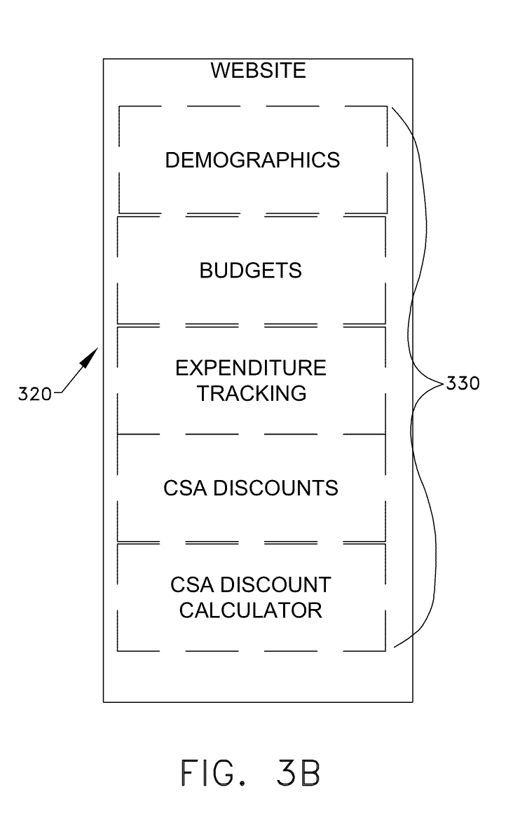

FIGS. 3A and 3B illustrate a block diagram of website operations in accordance with some embodiments of the present invention. The member data entry is entered via one or more member data entry graphical user interfaces (GUIs). The system may include financial goals determination unit and/or related GUIs to enter, evaluate and/or assess or estimate a person's financial goals. The website may include a member savings estimator to estimate potential savings for using the service of the MLC system. The website includes a bill paying service unit and related GUIs. The website includes a budget amount activation unit and related GUIs. The website includes a member service and communication unit to communicate, alert and notify the MLC member. The website includes a transaction statement generator. Transactions include various types of financial transactions such as bill payments, bills due, purchases, account balances, deposits and transactions related to one or more merchants. The statements may be text messages, email messages, hard copy mail or a combination thereof. The website may enable an RSS feed to update the user on changes to their accounts or financial market.

The website includes a transaction discount communication unit to notify the member of the amount of discount or savings. The website includes a private sale club unit and travel service unit.

The website may include an insurance solicitation and purchase unit and a financial safety determination unit. The website includes a cost saving determination unit for calculating a cost saving associated with a merchant-POS. The website may include a Personal Shopper Services unit, a REIT or other investment services unit, real estate services unit, and/or a mortgage/loan services unit. Each of these units may include one or more GUIs to enter additional member information related to the service. For example, the mortgage/loan service unit would provide data entry fields to enter a loan amount, years, interest rate, property location, and/or other information required to obtain a mortgage loan. These financial services units may provide data entry fields for acquiring a particular financial instrument such as stocks, bonds, IRA, commodities, etc.

The website may include a cost savings depositor unit to deposit into a MLC account cost savings as the result of using a MLC bank card. The website interfaces with a Bank (Bank Card or Credit Card Issuer) to set up bank accounts at the bank. The members deposit money or salary into a member bank account so all purchases may be made with the Bank issued Debit/Credit Card. The Bank communicates all transaction to the website including at least the merchant ID and transaction amount.

The Bank and/or website may include a MLC purchase card approval and issuer unit to approve and generate a MLC purchase card that is presented at the merchant-POS. The website may also be required to approve a bank card so that only members utilize the services provided by the website.

The website may include units or modules to enter and evaluate member demographics for direct marketing to merchants. The website may include units for analyzing budges, expenditure tracking, merchant discounts and a merchant discount calculator. The website will keep track of all merchant discounts. The discounts may be a function of a particular service associated with the merchant. Thus, each merchant may have one or more discounts depending on the service or products. The expenditure tracking would allow the website to provide information to the merchants about the amount of money being spent on merchants products or similar products offered by competitors for customized marketing to the website members.

One or more of the units or modules may be omitted. One or more of the modules or units may require human intervention or may be fully automated.

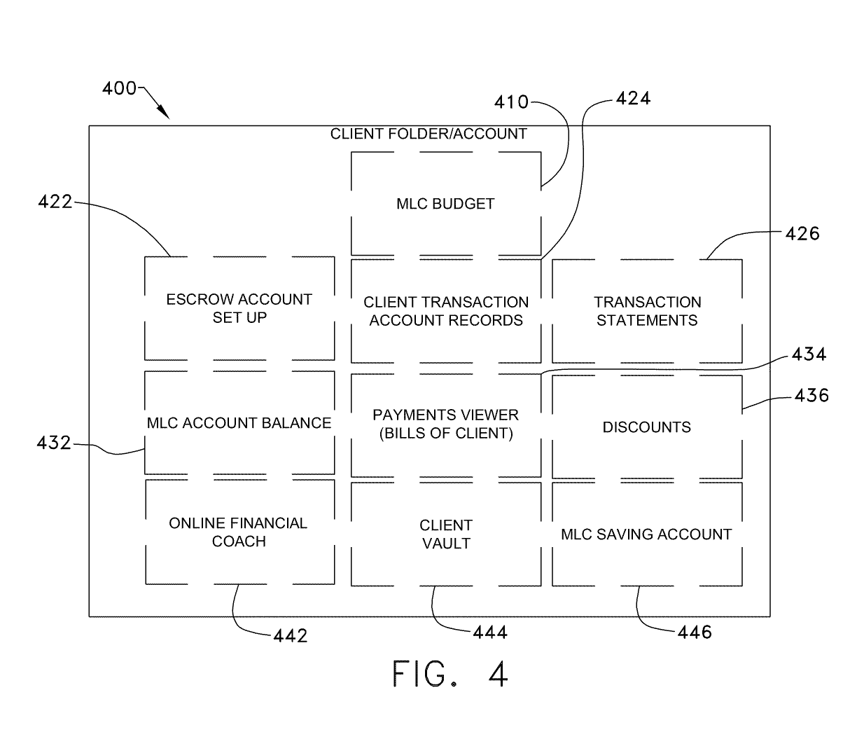

FIG. 4 illustrates a block diagram of client folder/account in accordance with some embodiments of the present invention. The folder/account may include client transaction account records and transaction statements, discount postings, payments viewer as well as an MLC escrow account balance. Other information may be presented to the MLC member via GUIs such as described herein. The information may include notifications, low balance alerts, discount alerts, savings, alerts when there is money available to spend, alerts comparing different financial categories (e.g., actual spent for food compared to actual spent for housing over a predetermined time period), etc. The folder/account may include an optional escrow account (e.g., holding or fiduciary account) setup module. The escrow account may be for the benefit and use of the member and/or for the benefit and use of another. The website may include a member document vault to store important documents for the member including bills, insurances, and other important documentation.

The folder may include statements related to the MLC saving account for the member. The folder also provides the member with the MLC budget. The folder would provide the necessary GUIs to enter a budget by the member and budget (dollar) amounts or limits for each category.

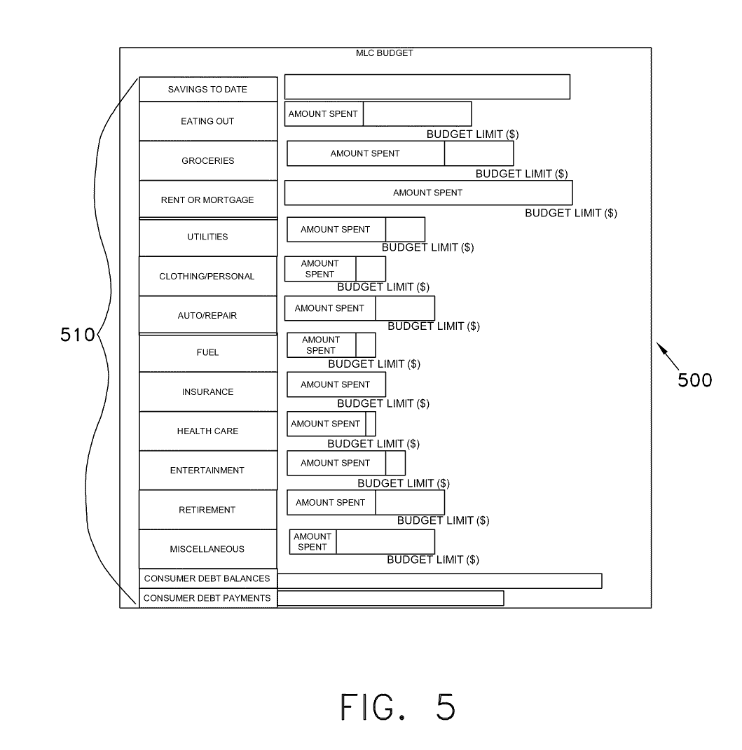

FIG. 5 illustrates a block diagram of a member's MLC budget GUI in accordance with some embodiments of the present invention. The budget may be represented in bar graph representation 500. Exemplary budget categories may include eating out, groceries, rent or mortgage, utilities, clothing/personal, auto/repair, fuel, insurance, health care, entertainment, retirement and miscellaneous. Still in further embodiments, the budget categories may include such data as identified in Table 1 below:

TABLE 1

| Budget Category: | Examples of Purchases for this Budget |
|---|---|
| Housing | Rent or Mortgage Payments, Condo Dues, Repairs |
| Transportation | Auto Repairs, Gasoline, Taxi, Bus or Train Fares |
| Food | Grocery Stores, Restaurants, Alcohol, Cigarettes |
| Clothing | Clothes, Shoes |
| Entertainment | Golf, Movies, Sporting Events, Spas |
| Utilities | Electric, Gas, Internet, Cable, Cell Phones |
| Professional Fees | Legal, Accounting, Non-Medical |
| Insurance | Auto, Homeowners, Medical, Renters Ins. |
| Furniture | Furniture, Appliances, Home Décor |
| Health Care | Out of Pocket Medical, Dental, Prescriptions |
| Investments | Rental Property, Mutual Funds, CDs |
| Charities | Tithing, Non-Profit Donations |
| Personal | Hair & Nail Salons |
| Education | School and College Tuition, Supplies, Child Care |
| Watercraft | Boat, Jet Ski, etc. Supplies and Storage Cost |
| Taxes | Federal, State, FICA, Medicare, Real Estate |
| Debt | Mortgages, Auto Loans, Consumer Debt |
| Retirement | IRAs, 401Ks, Pensions, Social Security |

As can be appreciated, other budget categories customized for the member may be provided. The bar graph representation includes the amount allocated, the amount used to date (daily, monthly or annually), and the budget category limit. The budget GUI allows the member to track expenditures and limit spending if desired.

The budget GUI may include a bar graph that reflects consumer debt payments and a bar graph that reflects consumer debt balances. Charging items without using the MLC debit card to artificially stay on budget will be “caught” by the amount of consumer debt payments and balances rising. In addition, there may be a “cash reserve” bar that reflects the amount of savings rising. A savings goal bar graph may be provided to illustrate a calculation of an expected monthly savings based on the percent of discounts and the amount budgeted per category.

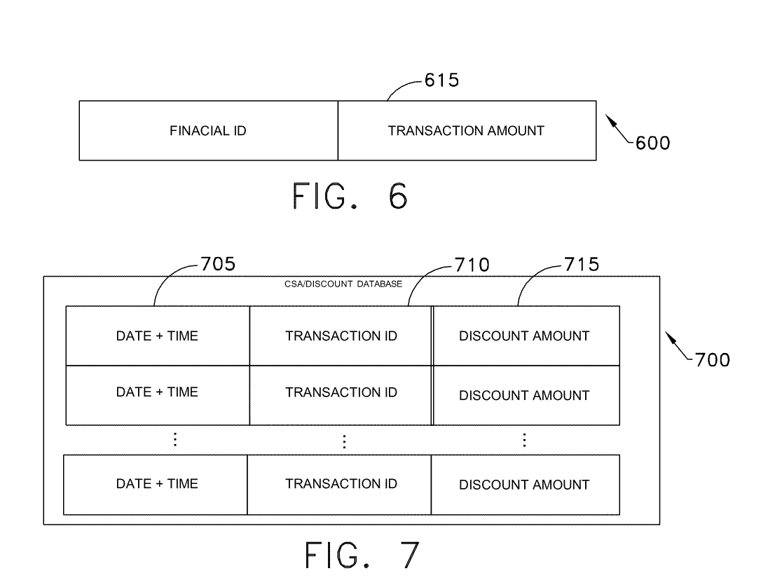

FIG. 6 illustrates a block diagram of a merchant transaction data stream in accordance with some embodiments of the present invention. Each merchant transaction is communicated to the bank (or financial institution) and website indicating at least the merchant ID and transaction amount. The bank receives the information so as to debit the member's account or to place on the member's credit. The transaction information is also used and sent to the MLC website so that the discount is calculated.

In operation, the member receives the discount at the point of sale. The sales receipt would indicate the transaction total and any discounts. The website will determine the savings based on the transaction total and the merchant ID. The transaction data may also include a transaction code if different discounts are provided for different products, services or a combination of products and services. The website generates a request to the bank to debit the member's account by the amount of savings and to place a portion of the saving in the website bank account as a revenue share and a portion of the savings in the member's revenue savings account.

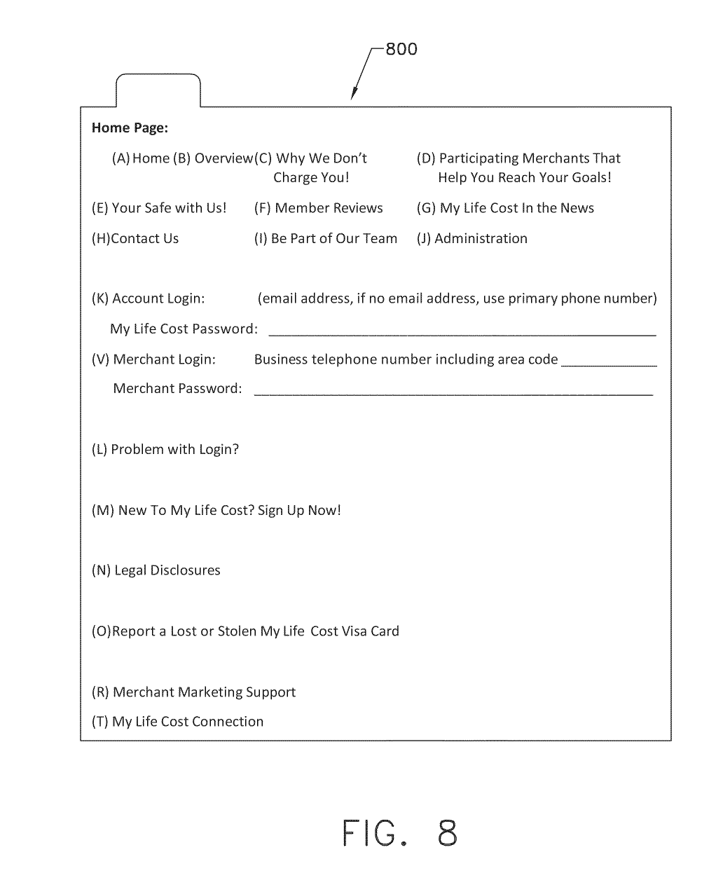

FIG. 7 illustrates a block diagram of the merchant/discount database in accordance with some embodiments of the present invention. The merchant/discount database would include the merchant, transaction ID, and financial incentive, such as a commission, marketing fee, discount, rebate or other amount (i.e., the incentive is quantified or based upon some method of determining a financial value for a member). A transaction code may also be used for different discount amounts for the same merchant.

The following description will describe various operations of the MLC system.

An applicant (potential member) may be solicited by a Financial Coach or a Employer Benefit Presenter. Alternatively, the applicant or potential member might respond to an advertisement or to a notice from a bank, lender, credit card company, merchant or other provider of a financial service or financial product.

The MLC system calculates potential savings for the member and the information is electronically sent to a Financial Coach or immediate contact. The Financial Coach may be automated and communications online. In the exemplary embodiment, each member is associated or assigned with a particular Financial Coach. The Financial Coach can be reached using the member folder or by phone. The Financial Coach provides member access to a human operator or combination of automated and human operators associated with the MLC website.

All insurance and investment documents will be stored in the member's secured document vault for 24 hour access by the member and MLC system. The member's document vault includes a member's billing statements from the system paying the member's debts, all billing statements (e.g., credit card entities, car payments, insurance, rent or mortgage payments, etc.), tax records and payments (federal, state, local and business taxes), and other important documents like wills, marriage certificate, birth certificate, medical records, Power of Attorney, titles to vehicles, deeds to property, contracts, security related documents and other records.

The member's budgeted amounts for their life cost are direct deposited into his escrow account from their pay or other deposit accounts. The member may begin using the MLC discount card. The escrow account may be used in conjunction with an MLC reserve savings account or alternatively, the two accounts may be combined into one aggregated MLC savings account.

In the event the member chooses to utilize MLC's complimentary bill paying service, the member will be instructed to open an escrow account at the bank or credit union utilized by MLC and its merchant, the bill paying CPA firm. The amount necessary to pay the life cost of the member will be deposited into the member's escrow account and the certified public accountant (CPA) firm will pay the member's cost from that account. The CPA firm will scan all the statements as they arrive into the member's secured document vault.

The member and MLC system may have 24 hour on-line access to the member's documents so that any questions or concerns can immediately be addressed. At the end of each month, the original billing statements, a copy of the escrow bank statement, and a balanced ledger of the member's escrow account will be sent to the member. Each calendar quarter, a copy of the three months of escrow statements (or alternate statements that report financial incentives, saving, credits, etc.) will be sent to a third party CPA firm for review to help insure the member's financial safety.

According to an exemplary embodiment, once a transaction/purchase is complete, a text message (communication) will automatically be sent to the member's cell phone (communications device) advising the member of the merchant, the amount of the net discounted sale, the amount of the total discount, the remaining balance of any budgeted category, and/or the amount to be deposited into the members MLC reserve or savings account or otherwise credited or valued for the benefit of the MLC member.

The MLC system may be configured to generate a daily email which is sent to the member as a notification of the prior day's activities, specifying where the transactions were made, the net sales amounts, the amount of the MLC discount and the amount deposited into the member's cash reserve account.

The MLC system may be configured to post in the member folder and/or email additional information that may include a list of merchant sales for each day, listed in alphabetical order (which rotates each day to give all the merchants fair advantage of being the first one listed), and the amount of additional savings the member can benefit from.

The MLC system may be configured to notify members of Merchant Daily Specials being currently offered. The Merchant Daily Special allows merchants to direct market to particular member demographics. Thus, a Merchant Daily Special may not be offered to all members but only to a particular set of members having a particular demographic.

The MLC system may be configured to provide on-line or electronically communicate, real time updates of the member's budget, referred to as “The Daily Budget Update” or a real time “ticker” that automatically notifies a member of spending, budgets, and other fields selected by a member for notification. The on-line budget update is configured to reflect the member's budgeted expense, how much is budgeted for that expense, the amount spent month to date and the amount still available for expenditure. The bottom of the budget may reflect the amount invested in the member's cash reserve yesterday, month to date and current balance. Below “The Daily Budget Update”, there may be a personal greeting from the member's Financial Coach advising the member of new merchants, a warm greeting or comments on their budget progress.

The MLC system or website is configured to track spending, and product and service purchases. Thus, the system may be used target items to the members.

The MLC system or website is configured to develop socio-demographics on members to perform socio-demographic profiling. The system may profile with over 10,000 items/combinations to target marketing for selling and marketing products. In other words, merchants may be provided statistics on social-demographic profiles of members so that the merchant may market to members based on the profiles.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The system may be configured to have a “roll-up” functionality data where one member is designated as a primary member and other members are linked to the primary member. For example, if a member (primary member) may link to folders or budgets of elderly parents, college student, etc. on the MLC system. The primary member would have access to the linked members budget. Additionally, the linked member's budget may be rolled up with the primary member. The primary member may have the ability to monitor the performance of the linked member.

For a college student, the primary member may have a primary bank card and dependent bank cards. The dependent bank card would be for the college student with a limited budget associated for the life style of the college student. The system would allow the primary member (parent) to monitor spending by the dependent member and replenish money as needed. The primary member may also ensure (track) that the dependent member's bills are paid timely.

FIG. 8 provides a exemplary illustration of the My Life Cost website home page functionality in accordance with some of the embodiments of the present invention. As shown the My Life Cost home page includes member login, merchant login, reports, support, about us, and other useful features.

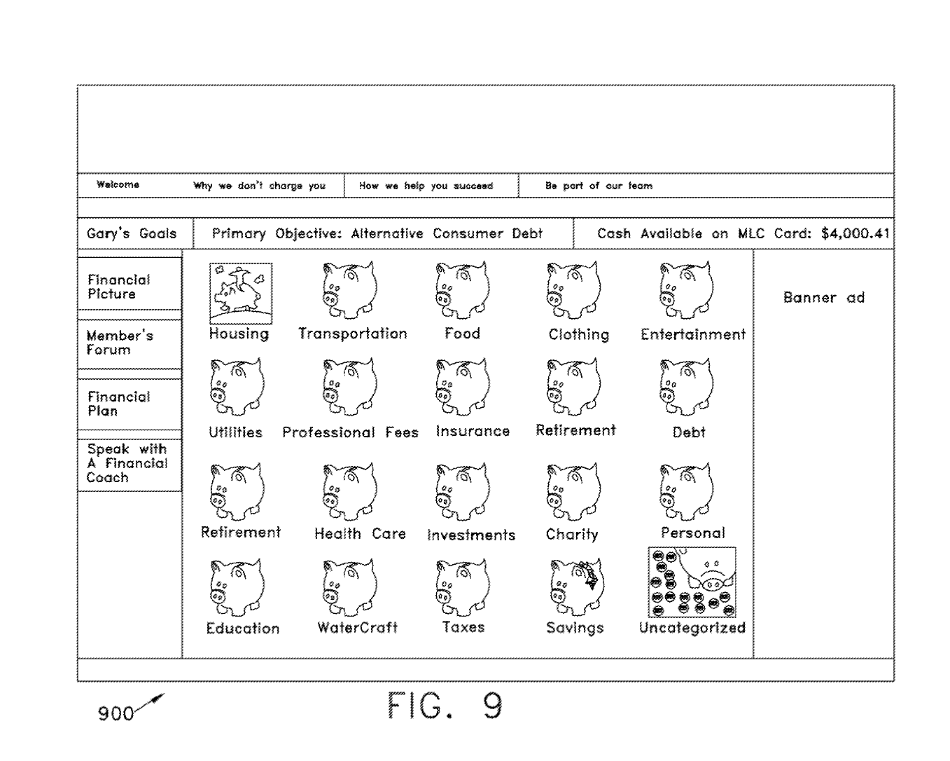

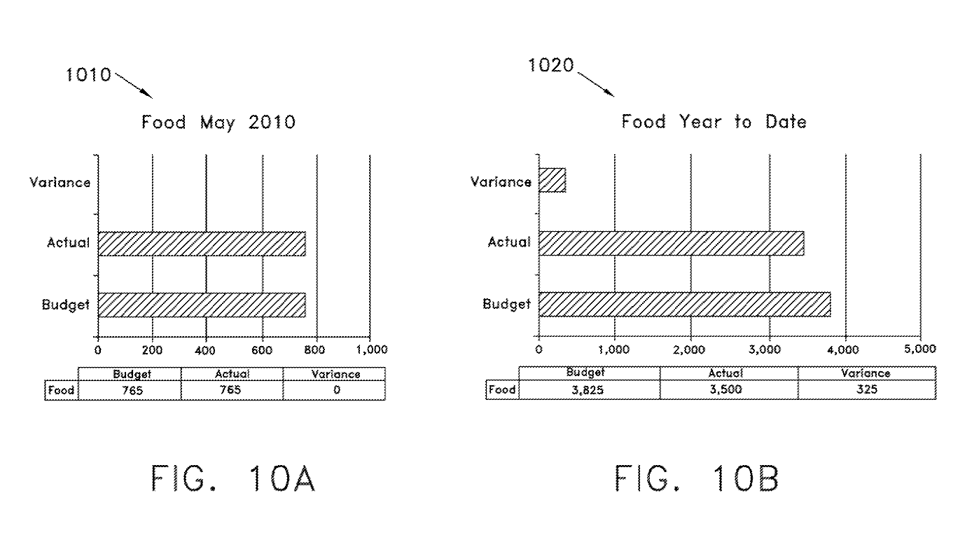

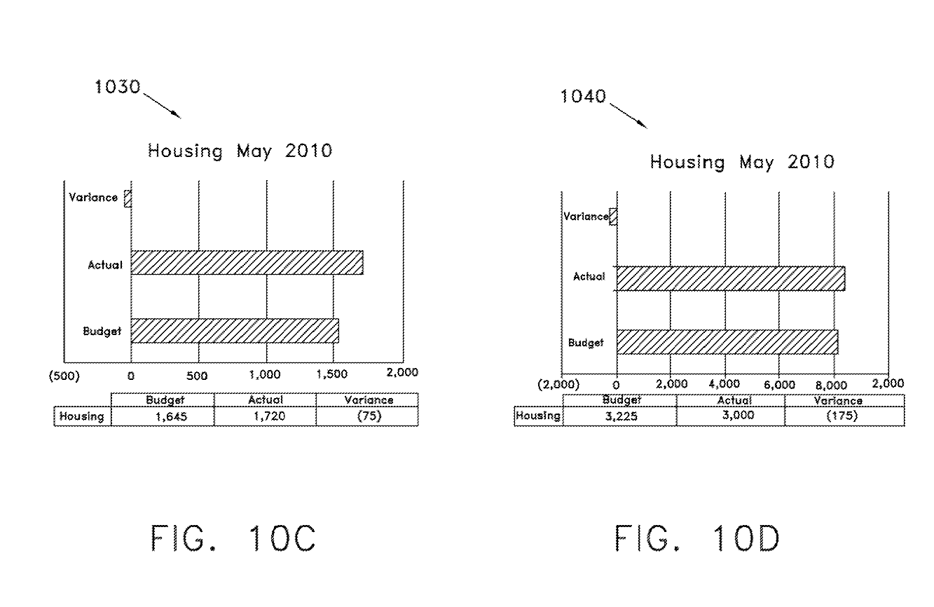

FIG. 9 illustrates an exemplary My Life Cost graphical user interface of a consumer objective to establish budget categories, and thus manage or otherwise eliminate debt (if any) in accordance with some of the embodiments of the present invention.

FIGS. 10A, 10B, 10C and 10D illustrate exemplary My Life Cost graphical user interfaces that assist a consumer in making an informed spending decision in accordance with some of the embodiments of the present invention. As shown, these figures provide detailed information for food and housing budgets, expenditures, and remaining budget (or overdraft(s)/overbudget).

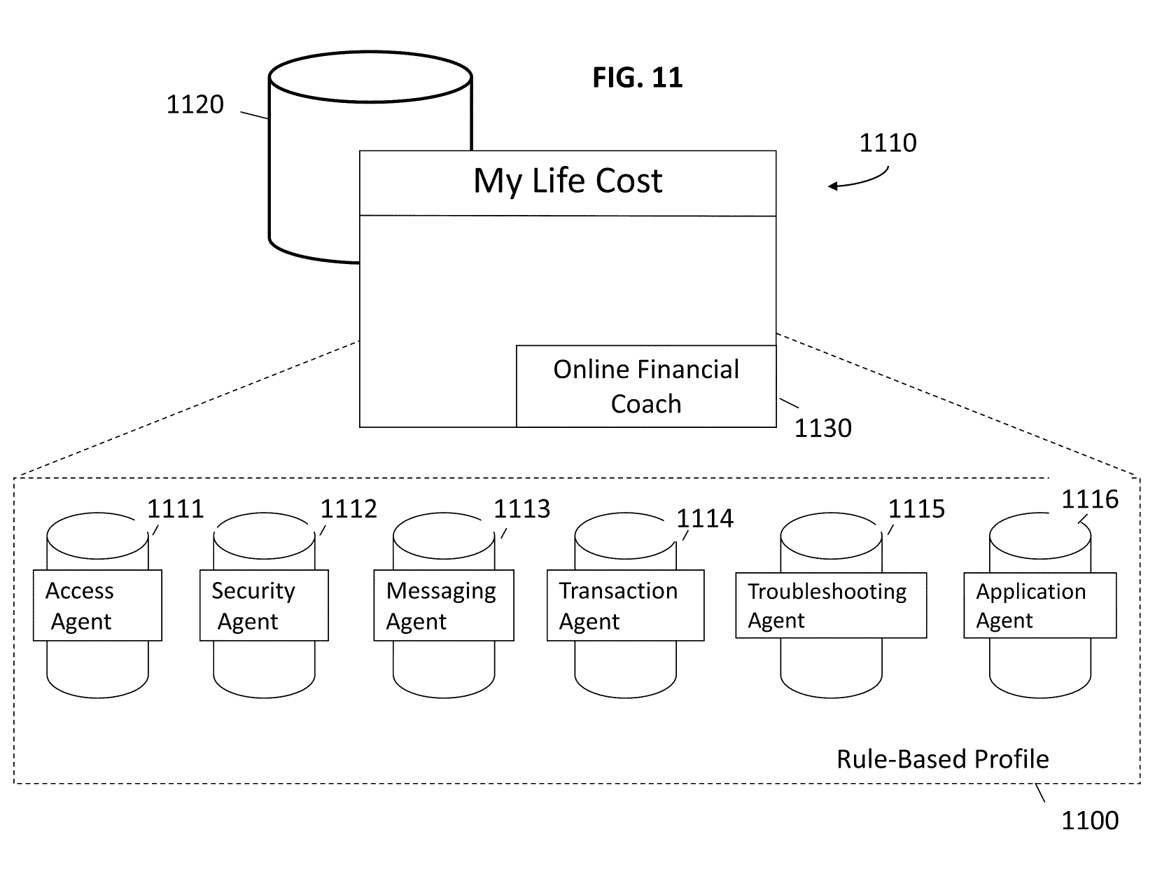

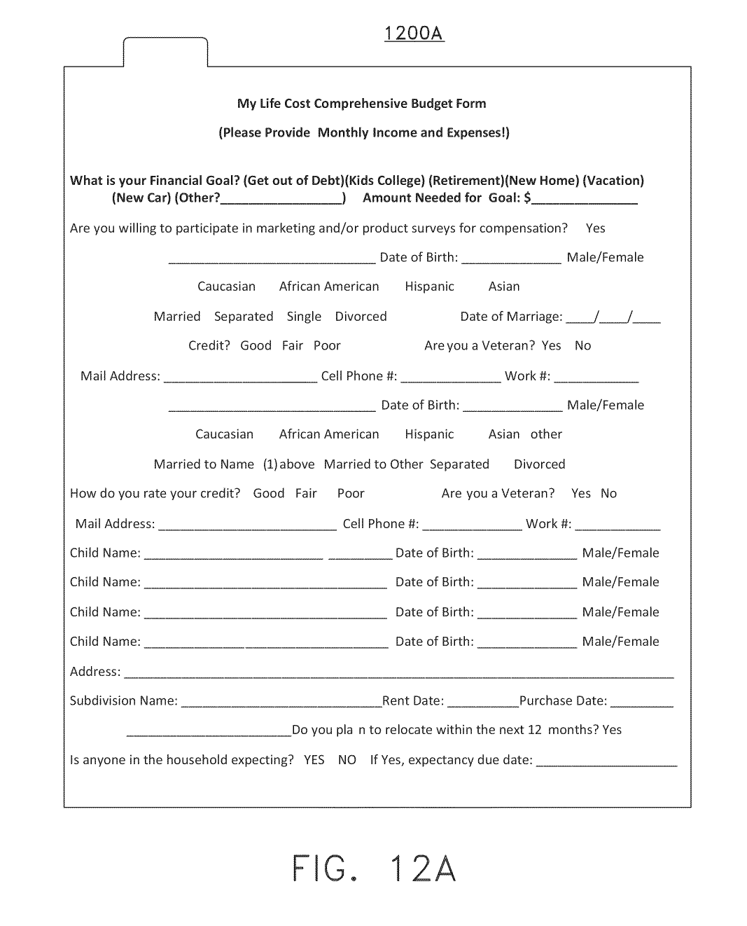

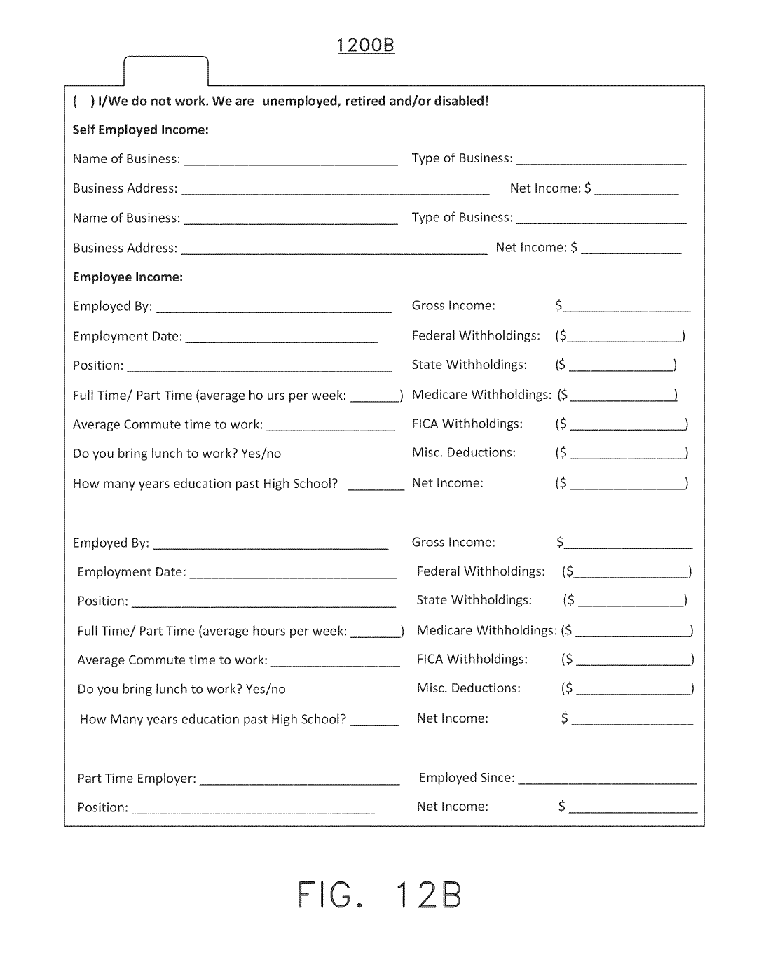

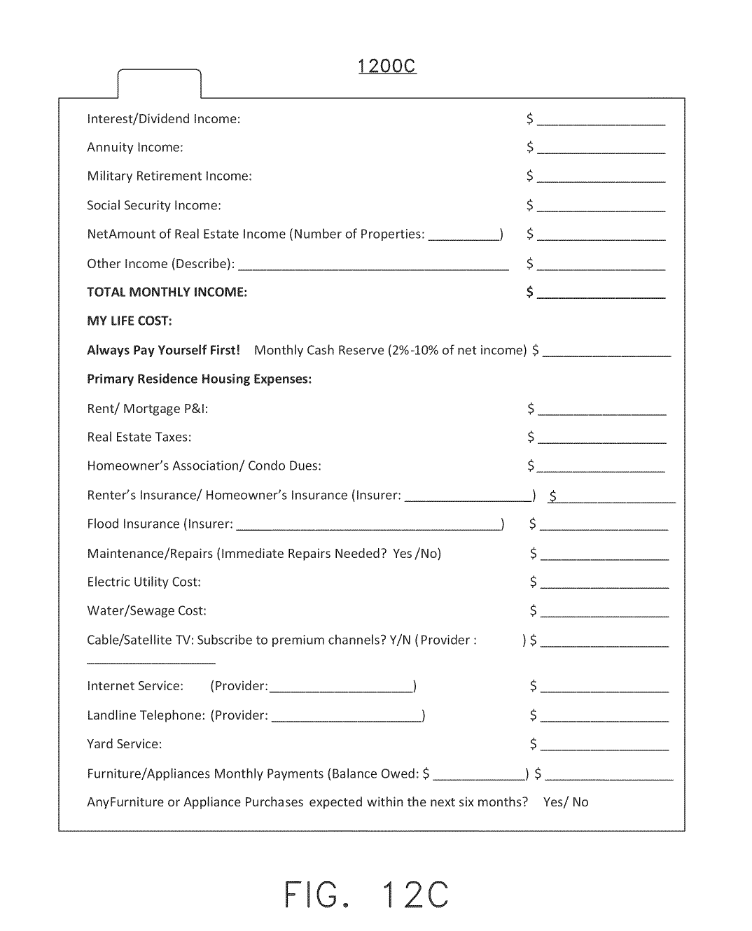

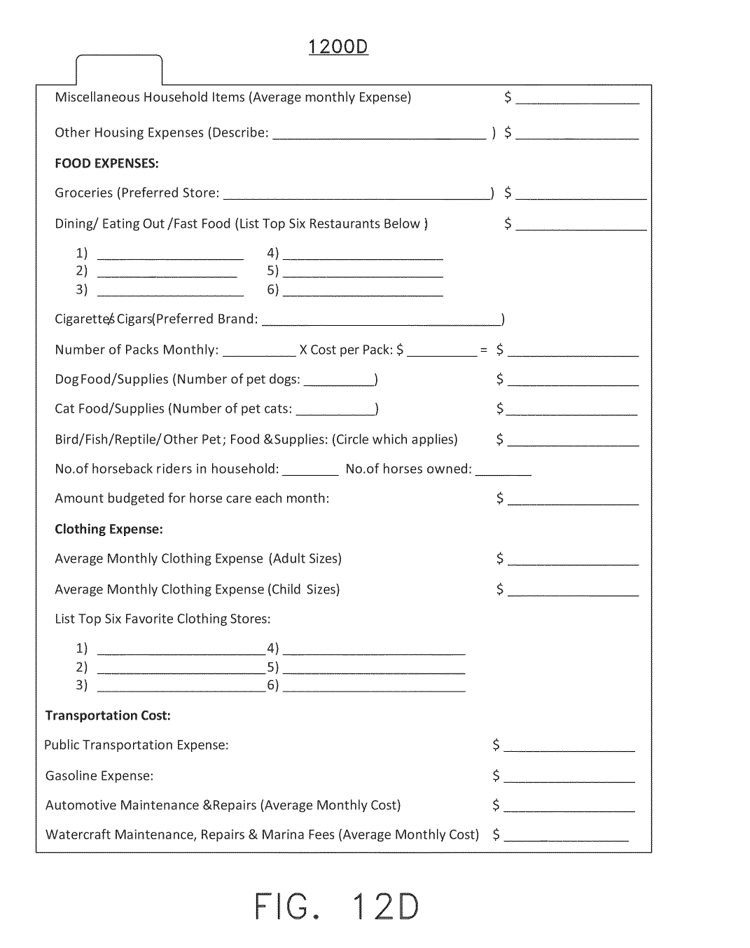

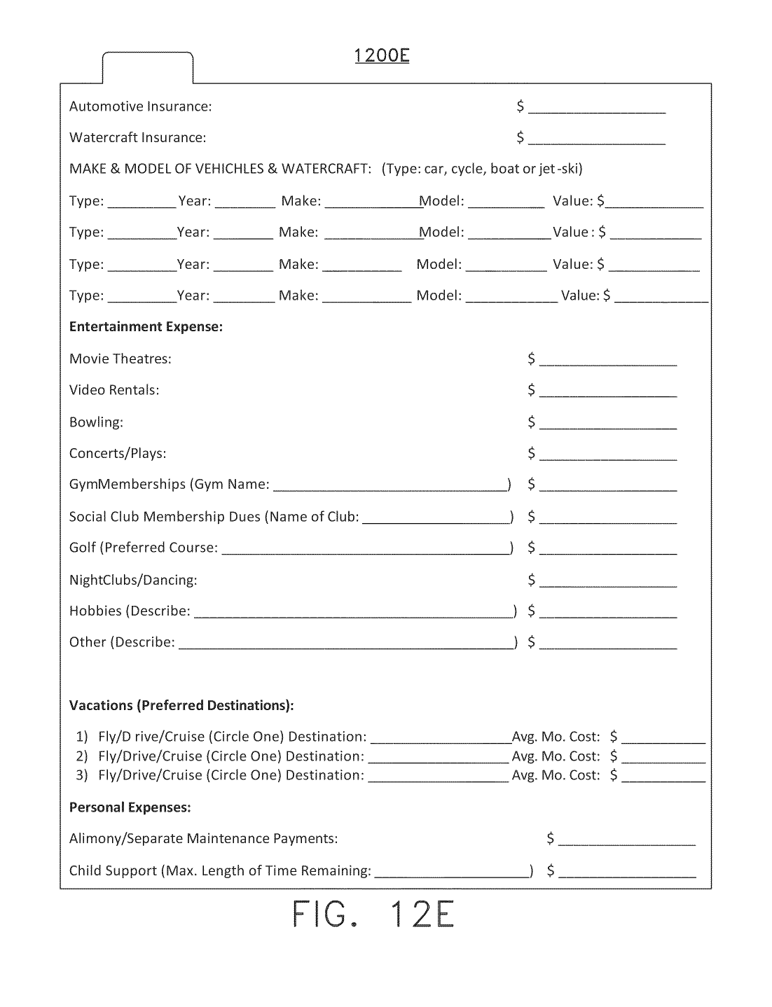

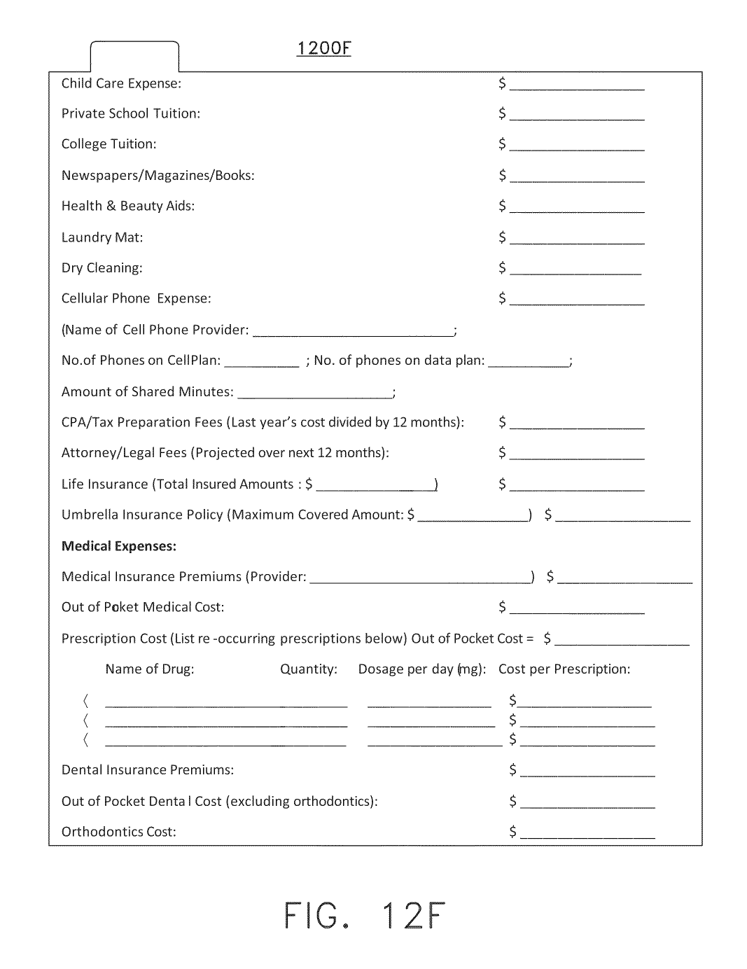

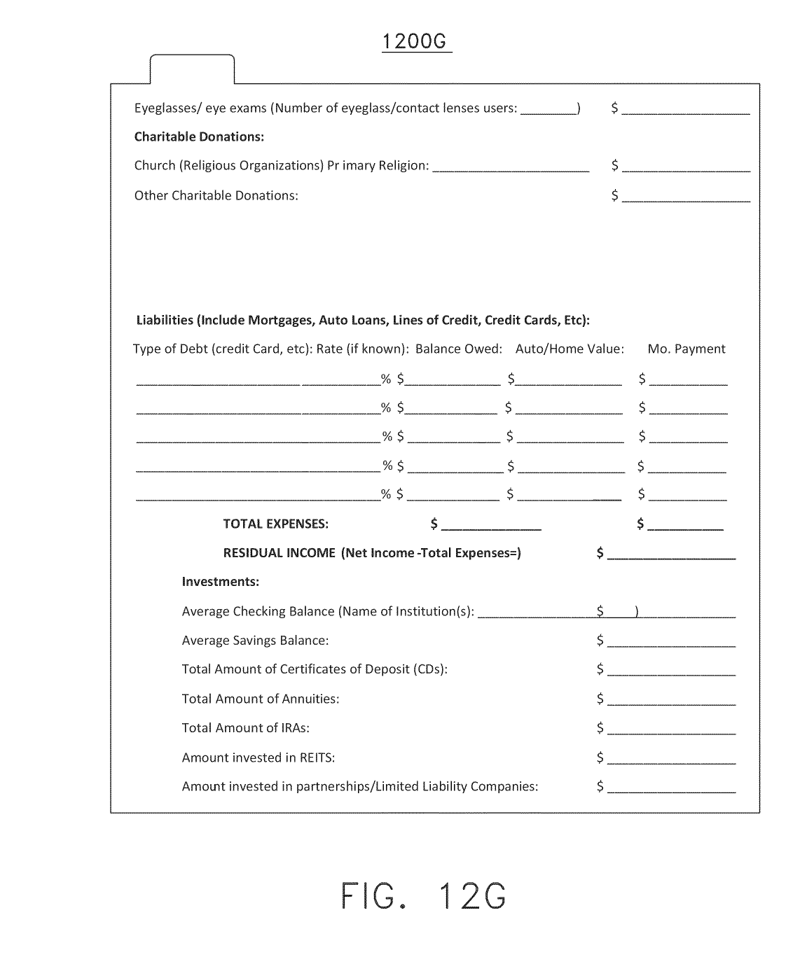

FIG. 11 illustrates a block diagram of a My Life Cost method and system that provide an online financial coach to assist with informed consumer spending in accordance with some of the embodiments of the present invention. As shown, the financial coach is provided various tools to customize assistance to each counseled member. These tools include an access agent 1111 to manage access to MLC database information, a security agent 1112 to manage secured communications, a messaging agent 1113 for various non-secured communications as well as other messaging information, a transaction agent 1114 for managing financial, spending and other transactions, a troubleshooting agent 1115 for managing and helping a member, and an application agent 1116 for interfacing with other software applications and tools to assist the financial coach and/or member.

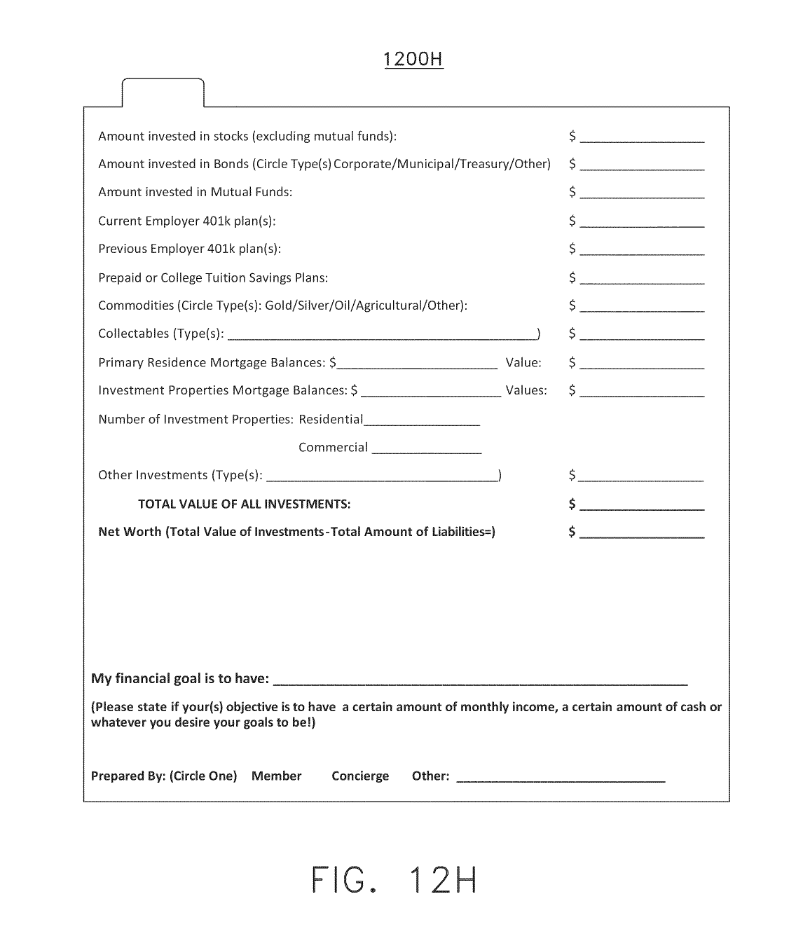

FIGS. 12A thru 12H illustrate an exemplary query or interactive online form for collecting consumer/member data in accordance with some of the embodiments of the present invention. This data is used to populate the MLC database with a member's profile, to assist with managing and helping a member create budget categories, and to assist the consumer with overcoming debt or modify or assist with managing spending habits.

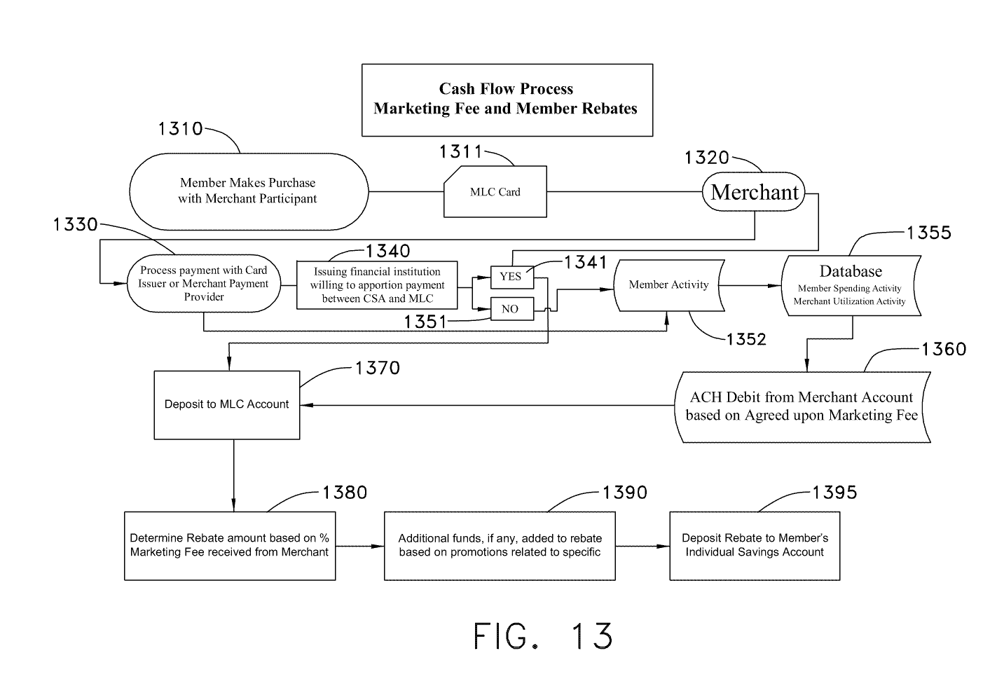

FIG. 13 illustrates a flow chart depicting some of the earlier described My Life Cost methods in accordance with some of the embodiments of the present invention.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method, comprising:
receiving member transaction data, the member transaction data comprising an amount of a financial transaction, a financial savings indicator, and a merchant identifier, the member transaction data further associated with at least one of a payor identifier for the financial transaction, a ratio to apply to the financial savings indicator for the benefit of a member, a budget identification category, an identification category for an offering provided by a merchant associated with the merchant identifier, a merchant communications address, a physical address of the merchant, and a data and time of the financial transaction;
storing the member transaction data; and
presenting the member transaction data to a media device.

2. The method of claim 1, wherein the media device comprises:
a remote control device,
a mobile phone,
a cellular phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

3. The method of claim 1, further comprising:
receiving a search parameter for searching the member transaction data, the search parameter comprising at least one of geographic coverage of the merchant, an identification category for a good or service provided by the merchant, availability data associated with the financial savings indicator, and on-time payment data;
selecting the merchant having a matched search parameter; and
presenting an advertisement associated with the selected merchant to the media device.

4. The method of claim 1, further comprising:
simultaneously presenting a media stream associated with a member's profile to the media device and the member transaction data; and
presenting a media stream to an alternate media device authorized by the member.

5. A method for selecting an advertisement, comprising:
accessing member data, the member data comprising at least one member criterion describing one or more consumers as desirable for receiving advertisement content;
selecting advertising data, auction data for selecting and bidding on the advertisement time slot, and business data for awarding the advertisement, wherein selecting the advertisement data comprises:
i) matching the member data with the auction data and the advertising data to identify one or more advertisements as desirable for distribution to the one or more media devices associated with desirable consumers,
ii) establishing a price for each of the identified one or more advertisements, and
iii) awarding the advertisement to maximize an expected contract price for the advertisement.

6. The method of claim 5, further comprising:
communicating the advertisement data to at least one media device associated with at least one desirable consumer.
